(19) United States
(12) Patent Application Publication
(10) Pub. No.: US 2016/0373166 A1
(43) Pub. Date: Dec. 22, 2016

(54) PROXIMITY SENSOR FOR DEEP SLEEP WAKEUP OF WIRELESS CHARGER

(71) Applicant: INTEL CORPORATION, Santa Clara, CA (US)

(72) Inventors: Songnan Yang, San Jose, CA (US); Steven G. Gaskill, Corvallis, OR (US); Ahmad Khoshnevis, Portland, OR (US); Anand S. Konanur, Sunnyvale, CA (US); Ulun Karacaoglu, San Diego, CA (US)

(73) Assignee: INTEL CORPORATION, Santa Clara, CA (US)

(21) Appl. No.: 14/864,303

(22) Filed: Sep. 24, 2015

Related U.S. Application Data
(60) Provisional application No. 62/180,951, filed on Jun. 17, 2015.

(51) Int. Cl. H04B 5/00; H04W 40/24; H04W 52/02

(52) U.S. Cl. CPC H04B 5/0037; H04W 52/0241; H04W 40/244

(57) ABSTRACT

The disclosure relates to a method, apparatus and system for power transmission unit (PTU) having a sensing unit. The sensing unit may be integrated with the PTU to determine when a power receiving unit (PRU) is proximal and awaken the PTU's charging coil. When a PRU is not present, the PTU may be in Deep Sleep state to save power.

### CROSS-REFERENCE TO RELATED APPLICATIONS

The disclosure claims the filing-date benefit of application Ser. No. 62/180,951 (filed Jun. 17, 2015), the specification of which is incorporated herein in its entirety. The disclosure also incorporates herein by reference application Ser. No. 14/862,423, filed September 23, entitled “Method, System and Apparatus to Optimize A4WP Wireless Charging and NFC Co-Existence”, (assignable to the assignee of the instant application and having at least one common inventor) in its entirety for background information.

### BACKGROUND

Field

The disclosure relates to safe and improved wireless charging stations including proximity sensor based deep sleep wake up for A4WP wireless charging. The disclosed embodiments provide a low power, low cost, localized deep-sleep wake up wireless charging station which offers significant power saving and provides enhanced user experience.

Description of Related Art

Wireless charging or inductive charging uses a magnetic field to transfer energy between two devices. Wireless charging can be implemented at a charging station. Energy is sent from one device to another device through an inductive coupling. The inductive coupling is used to charge batteries or run the receiving device. The Alliance for Wireless Power (A4WP) was formed to create industry standard to deliver power through non-radiative, near field, magnetic resonance from the Power Transmitting Unit (PTU) to a Power Receiving Unit (PRU).

The A4WP defines five categories of PRU parameterized by the maximum power delivered out of the PRU resonator. Category 1 is directed to lower power applications (e.g., Bluetooth headsets). Category 2 is directed to devices with power output of about 3.5 W and Category 3 devices have an output of about 6.5 W. Categories 4 and 5 are directed to higher-power applications (e.g., tablets, netbooks and laptops).

PTUs of A4WP use an induction coil to generate a magnetic field from within a charging base station, and a second induction coil in the PRU (i.e., portable device) takes power from the magnetic field and converts the power back into electrical current to charge the battery. In this manner, the two proximal induction coils form an electrical transformer. Greater distances between sender and receiver coils can be achieved when the inductive charging system uses magnetic resonance coupling. Magnetic resonance coupling is the near field wireless transmission of electrical energy between two coils that are tuned to resonate at the same frequency.

Wireless charging is particularly important for fast wireless charging of devices including smartphones, tablets and laptops. There is a need for scalable wireless charging systems to provide a large charging area capable of simultaneously charging of multiple devices.

### BRIEF DESCRIPTION OF THE DRAWINGS

These and other embodiments of the disclosure will be discussed with reference to the following exemplary and non-limiting illustrations, in which like elements are numbered similarly, and where:

FIG. 1A shows a simplified exemplary apparatus according to one embodiment of the disclosure;

FIG. 1B shows an exemplary PTU which may be used with the apparatus of FIG. 1A;

FIG. 2 shows an exemplary PTU state machine according to one embodiment of the disclosure;

FIG. 3A shows a conventional beacon sequence of an A4WP Power Transmission Unit;

FIG. 3B illustrates beacon signaling and Deep Sleep State according to one embodiment of the disclosure;

FIG. 4A shows a wake-up sequence according to the first exemplary embodiment of the disclosure;

FIG. 4B shows transition to Low Power State to conserve power according to one embodiment of the disclosure;

FIG. 5 shows an exemplary apparatus according to one embodiment of the disclosure;

FIG. 6 illustrates another embodiment of the disclosure with an equivalent circuit for delta-sigma (As) capacitive to digital converter sensor; and

FIG. 7 shows an exemplary embodiment according to one embodiment of the disclosure of a two-stage differential Twin-T notch filter.

### DETAILED DESCRIPTION

Certain embodiments may be used in conjunction with various devices and systems, for example, a mobile phone, a smartphone, a laptop computer, a sensor device, a Bluetooth (BT) device, an Ultrabook™, a notebook computer, a tablet computer, a handheld device, a Personal Digital Assistant (PDA) device, a handheld PDA device, an on board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AV) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Institute of Electrical and Electronics Engineers (IEEE) standards (IEEE 802.11-2012, IEEE Standard for Information technology-Telecommunications and information exchange between systems Local and metropolitan area networks—Specific requirements Part 11: Wireless LAN Medium Access Control (MAC) and Physical Layer (PHY) Specifications, Mar. 29, 2012; IEEE 802.11 task group ac (TGac) (“IEEE 802.11-09/0308r12—TGac Channel Model Addendum Document”); IEEE 802.11 task group ad (TGad) (IEEE 802.1 lad-2012, IEEE Standard for Information Technology and brought to market under the WiGig brand—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60GHz Band, 28 Dec. 2012)) and/or future versions and/or derivatives thereof, devices and/or networks operating in accordance with existing Wireless Fidelity (Wi-Fi) Alliance (WFA) Peer-to-Peer (P2P) specifications (Wi-Fi P2P technical specification, version 1.2, 2012) and/or future versions and/or derivatives thereof, devices and/or networks operating in accordance with existing cellular specifications and/or protocols, e.g., 3rd Generation Partnership Project (3GPP), 3GPP Long Term Evolution (LTE), and/or future versions and/or derivatives thereof, devices and/or networks operating in accordance with existing Wireless HDTM specifications and/or future versions and/or derivatives thereof, units and/or devices which are part of the above networks, and the like.

Some embodiments may be implemented in conjunction with the BT and/or Bluetooth low energy (BLE) standard. As briefly discussed, BT and BLE are wireless technology standard for exchanging data over short distances using short-wavelength UHF radio waves in the industrial, scientific and medical (ISM) radio bands (i.e., bands from 2400-2483.5 MHz). BT connects fixed and mobile devices by building personal area networks (PANs). Bluetooth uses frequency-hopping spread spectrum. The transmitted data are divided into packets and each packet is transmitted on one of the 79 designated BT channels. Each channel has a bandwidth of 1 MHz. A recently developed BT implementation, Bluetooth 4.0, uses 2 MHz spacing which allows for 40 channels.

Some embodiments may be used in conjunction with one way and/or two-way radio communication systems, a BT device, a BLE device, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like. Some demonstrative embodiments may be used in conjunction with a WLAN. Other embodiments may be used in conjunction with any other suitable wireless communication network, for example, a wireless area network, a “piconet”, a WPAN, a WVAN and the like.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

Ubiquitous availability of wireless chargers in places such as offices, conference rooms, coffee shops, airports, hotels and the like is highly desirable. In the conventional A4WP Base System Specification (BSS), the PTU is required to periodically transmit short and long beacons through PTU coil to detect device presence and initiate connection between PTU and PRU. Systems designed under this specification incur significant power when the system is idle. To curb power loss, deep sleep features are disclosed herein which also enable fast power-up of the PTU when a nearby PRU is detected. The disclosed embodiments include sensing technology (for nearby PRUs) while the PTU is in the deep sleep mode. The sensing technology may be extended to sensing objects at or near the PTU. The sensed object may include human body, among other things.

Conventional methods for deep-sleep wakeup include powering a group of PTUs in the same room or in proximity of the PTU. Powering is triggered by motions sensor(s) deployed in, for example, a conference room or by Bluetooth proximity sensing. The conventional systems require significant additional hardware which add unnecessary power overhead. Further, detection accuracy and granularity is not sufficiently acute to allow each individual PTU to wake up. To address these and other deficiencies of the conventional systems, an embodiment of the disclosure relates to low power, low cost, localized deep-sleep wake-up schemes. The disclosed embodiments provide significant power saving and improved user experience.

In an exemplary embodiment, a sensing element is added to the PTU coil to detect proximal PRUs and/or objects (including humans). The PTU coil may comprise one or more resonators with corresponding circuitry to convert input voltage into magnetic field. As used herein, detection applies equally to detecting PRUs, wireless devices, object and human bodies equally. In one embodiment, the detected object (device, human, etc.) is connected to the ground potential. The sensing element may be a capacitive proximity sensor to offer localized detection when a PRU is introduced to the environment supported by the PTU. Capacitive sensors exhibit a change in capacitance in response to a change in physical stimuli. The sensor may provide a simplified, fast poling scheme for PRU detection. Once detected, the sensor may expeditiously awaken the PTU for charging the PRU. As compared with the conventional PTU systems (running on current A4WP specification), among others, the disclosed embodiments add deep-sleep mode to A4WP specification with significant power saving and scalability.

A conventional A4WP Class 4 PTUs may consume hundreds of milliwatts (mW) when in idle mode. The consumption is caused by sending short and long beacons periodically pursuant to the A4WP requirements. In certain embodiments, when a PTU system is in deep-sleep mode, the only circuitry in operation is the capacitive proximity sensor, which typically consumes microwatts of power. This, among others, provides significant overhead power reduction. As compared with alternative triggering techniques such as in room motion detector or Bluetooth based proximity sensor, the disclosed technique offers localized detection.

In one embodiment, the existing PTU coil may be used as the capacitive sensor electrode to limit detection to the immediate surroundings of the PTU coil. Advantageously, this feature allows the system to selectively wake up only when a PRU is within the charging area of the PTU. The capacitive sensor may be integrated with the resonator coil of the PTU or it may comprise an independent coil.

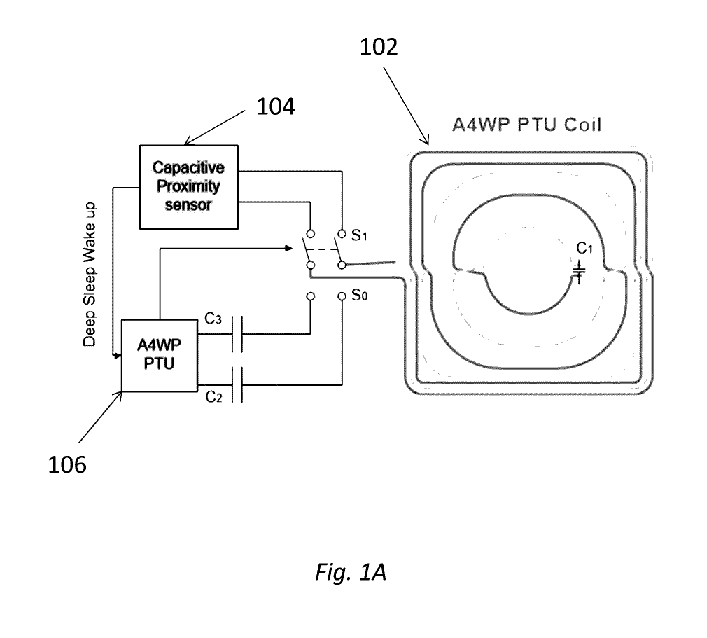

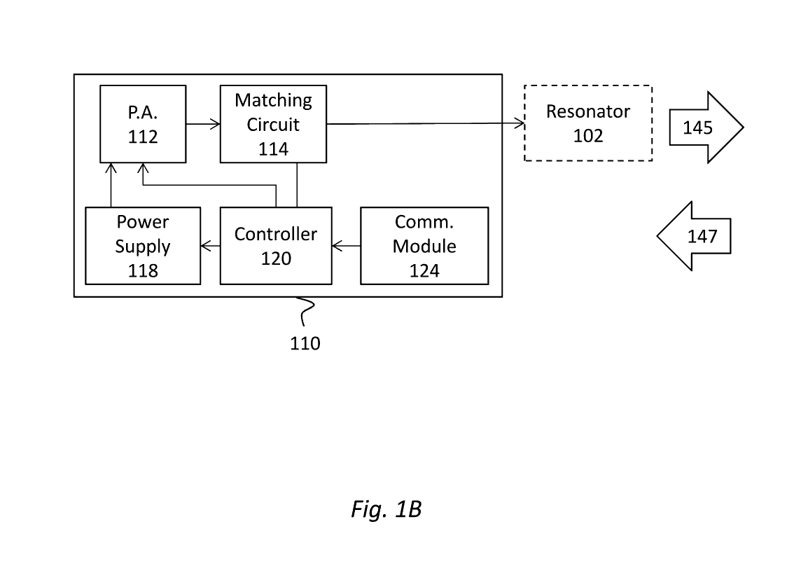

FIG. 1A shows a simplified exemplary apparatus according to one embodiment of the disclosure. The simplified apparatus of FIG. 1A may be used to awaken the PTU from deep sleep. FIG. 1A shows capacitive proximity sensor 104, PTU 106, switches (i.e., a single pole double throw switch with two states S₀ and S₁) and PTU Coil 102. PTU Coil 102 may comprise a resonator coil and associated circuitry to convert incoming power into magnetic field.

PTU Coil 102 may include a capacitor C₁, in line with the coil to provide low frequency isolation between two halves of the coil. In-line capacitors are commonly used in large coil designs to mitigate adverse effect of parasitic capacitance generated among turns of a large coil.

PTU 106 may be configured to operate as PTU back-end (described below in relation to FIG. 1B) and PTU Coil 102 may be configured to operate as A4WP resonator coil. PTU coil 102 is connected to capacitive proximity sensor 104 and to PTU 106 through switches (at state S₁ and state S₀ respectively).

During deep sleep mode, the front-end of the A4WP PTU (i.e., PTU coil 102) may be powered off to conserve power. Upon detecting an object near the active charge area (i.e., placing a device to charge on or near PTU coil 102), the capacitive proximity sensor 104 may send a wakeup signal to PTU 106. The wakeup signal can awaken PTU 106 to resume transmitting beacon signals under the A4WP standards. High frequency wireless charging may begin after PTU 106 confirms presence of a chargeable device at or near coil 102.

In certain embodiments of the disclosure, high frequency wireless charging (i.e., charging at 6.78 MHz) and low frequency capacitive sensing may be implemented on the same wireless charging coil (e.g., coil 102). Such implementations may multiplex the use of the coil along frequency or time domains. One such application is disclosed in application Ser. No. 14/862,423, filed Sep. 23, 2015 (Entitled: “Method, System and Apparatus to Optimize A4WP Wireless Charging and NFC Co-Existence”) which is incorporated herein in its entirety for background information.

Other techniques where capacitive proximity sensing may be implemented using differential coil for A4WP PTU and support of simultaneous power transfer and proximity sensing operations is discussed below. In an exemplary differential coil, the coil may be constructed from two symmetric halves and joint together at the center either by a capacitor or by direct connection. The coil may be driven differentially (i.e., neither end is grounded). At the center point, the coil is at a virtual ground.

FIG. 1B shows an exemplary PTU which may be used with the apparatus of FIG. 1A. Specifically, FIG. 1B shows the back-end of a conventional PTU configured to engage and direct resonator coil 102 to produce a desired magnetic field.

PTU 110 includes power supply 118, power amplifier (PA) 112, matching circuit 114, controller 120 and communication module 124. Resonator coil 102 (interchangeably, resonator) is discussed in relation to FIG. 1A. Resonator 145 communicates power to a resonator associated with the corresponding PRU (not shown). Communication module 124 may define BLE communication platform to transceive BLE packets and communicate the packet data to controller 120. PA 112 receives primary power from power supply 118 (which may be an AC/DC adaptor or an AC source) and generates an amplified A4WP power signal according to instructions from controller 120. Matching circuit 114 receive A4WP power signals from PA 112 and provides substantially constant power to resonator 116. Resonator 116 may include one or more resonator coils to convert output from matching circuit 114 to magnetic field for wireless device positioned within the charging zone of PTU 110.

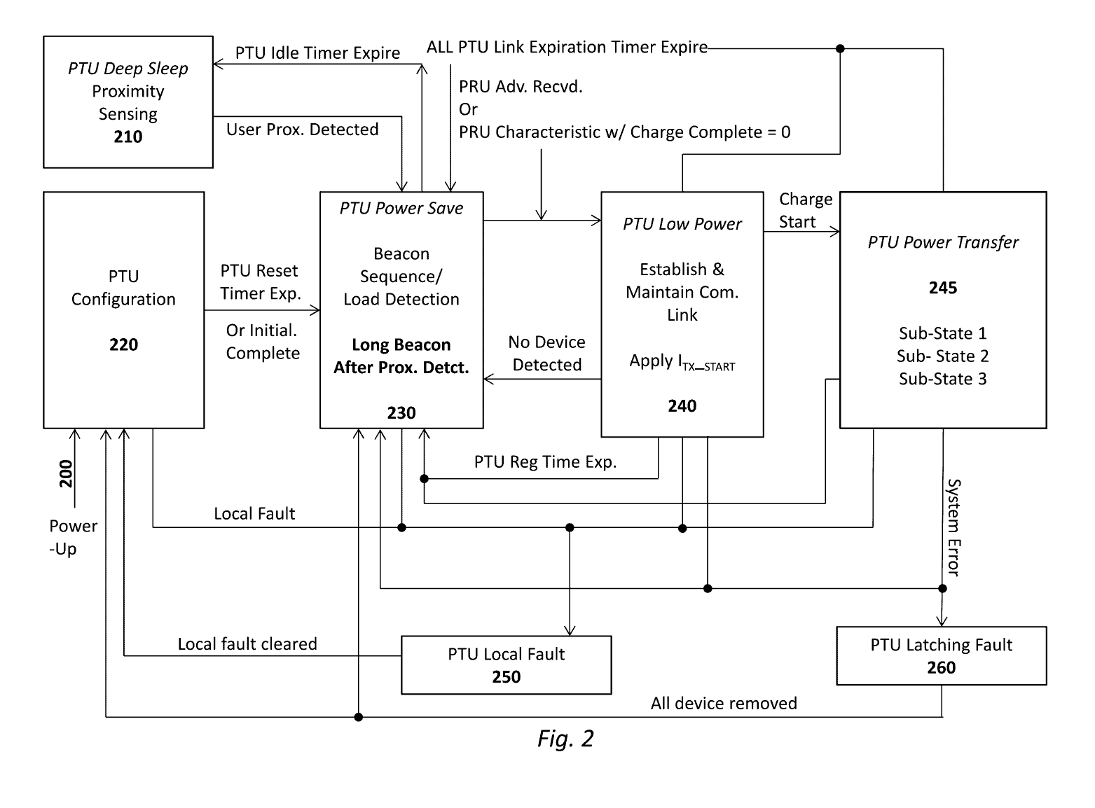

FIG. 2 shows an exemplary A4WP PTU state machine according to one embodiment of the disclosure. The state machine of FIG. 2 is shown with the following exemplary states: PTU Deep Sleep 210, PTU Power Save 230, PTU Low Power 240 and PU Power Transfer 245. FIG. 2 also shows PTU Configuration module 220, PTU Latching Fault 260 and PTU Local Fault 250.

During PTU powers up 200, PTU is in Configuration state 220 where the PTU is being initialized. The PTU enters Power Save state 230 when the PTU Resets Timer expires or when PTU initialization is completed. During PTU Power Save state 230 the PTU transmits a set of short beacons. According to one embodiment of the disclosure, if a nearby load is detected, then the short beacon is followed by a long beacon.

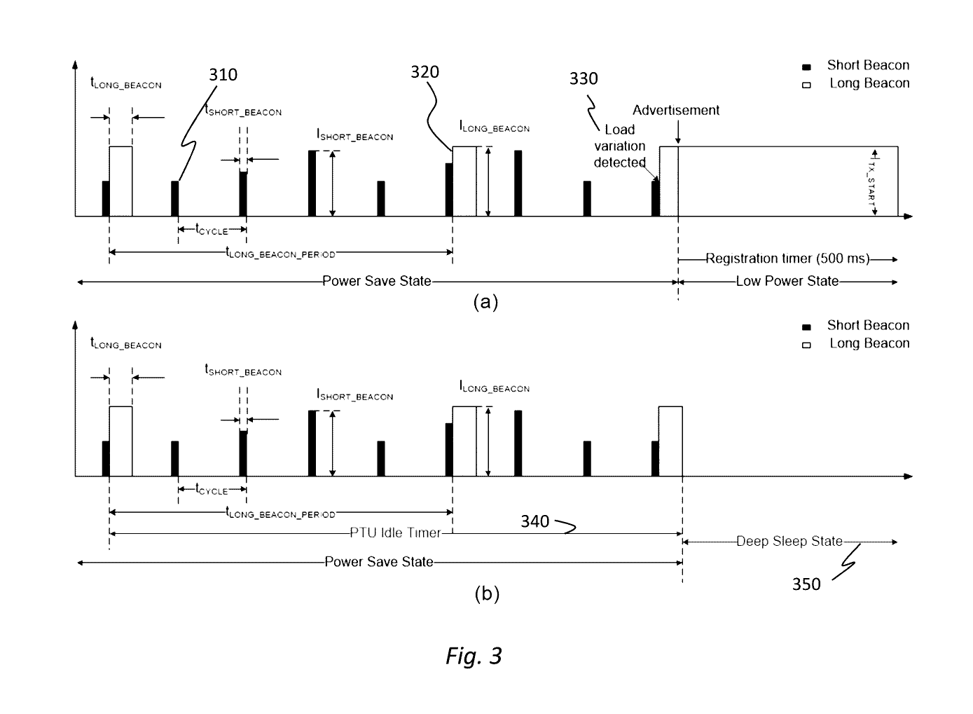

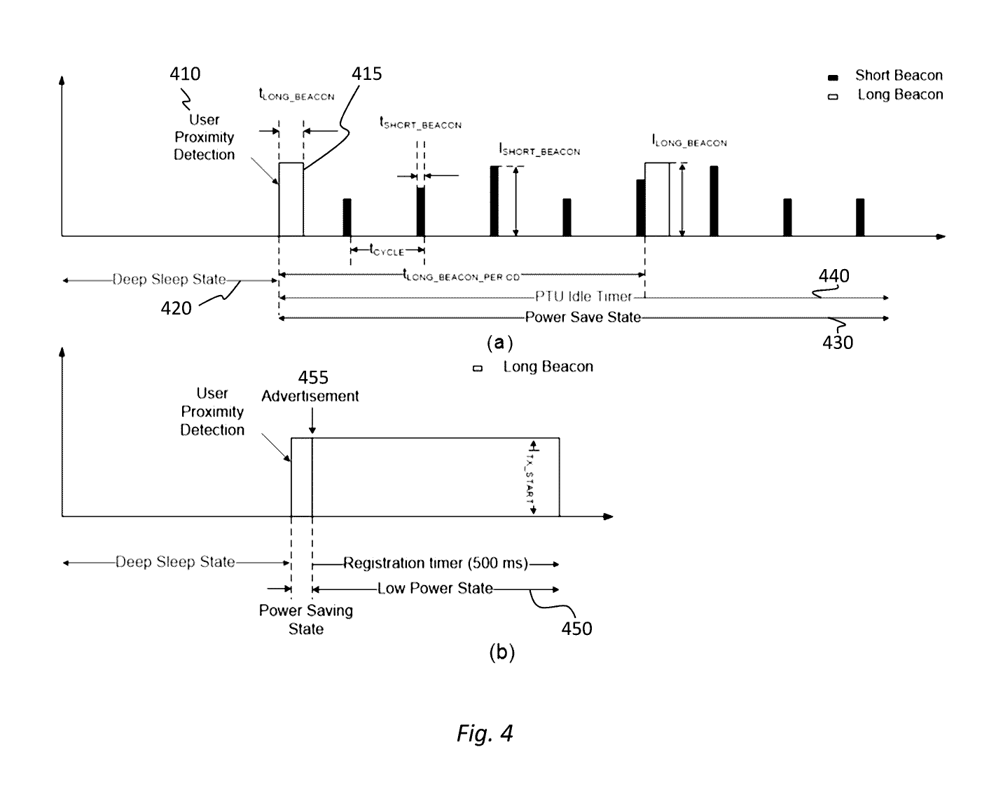

If BLE advertisement is received from a PRU during state 230 or if BLE packets are received indicating PRU characteristics, then the PTU enters PTU Low Power state 240. At this state, the PTU establishes and maintains a communication link with the PRU. In addition, the PTU transmits start current (I_{TX-START}) to energize the PTU coil. This step is further discussed below in reference to FIG. 3. On the other hand, if no device is detected during state 240, the PTU reverts back to state 230 and resumes transmitting beacon sequences.

Once the PTU confirms that the nearby PRU is ready to receive magnetic field, it enters PTU Power Transfer state 245. In this state, the PTU drives and energizes one or more resonator coils according to predefined criteria to provide optimal charging to the PRU. State 245 is shown with exemplary Sub-states 1, 2 and 3. Each sub-state denotes a different PTU power level. State 245 may continue until the PTU/PRU link expires or upon expiration of a pre-defined interval. At this time, the PTU may revert back to PTU Power Save State 230 or to PTU Low Power state 240. If the PTU encounters system error or other local faults at state 245, it may enter PTU Latching Fault state 260 or PTU Local Fault state 250, respectively. Once the Fault states are cleared, the PTU returns to the power-up state 200.

In certain embodiments, a proximity sensor may be used to introduce PTU Deep Sleep Proximity Sensing state 210. At this state, the PTU remains in deep sleep mode to maximize energy conservation. Once user proximity is detected, the PTU bypasses state 220 and enters PTU Power Save state 230. Further, if the PTU Power Save state 230 fails to detect a nearby load, then the PTU may end state 230 and return to Deep Sleep mode 210. During PTU Deep Sleep state 210, the PTU may be entirely inactive while a proximity sensor remains engage. The proximity sensor power consumption may be at least an order-of-magnitude lower than PTU consumption during Power Save state 230. Deep Sleep state 210 does not impact PTU's power transfer state 245 and Low Power state 240 as the function and state transition of these states is the same as the current A4WP specifications (i.e., A4WP 1.3 BSS).

FIG. 3A shows a conventional beacon sequence of an A4WP Power Transmission Unit. In FIG. 3A, the x-axis denotes time and the y-axis denotes amplitude of the signals. FIG. 3A shows short beacons 310 and long beacons 320 transmitted periodically while the PTU is in the Power Save State. Conventionally, the PTU transmits a short beacon during each t_cycle (t_{cycle}) and a long beacon each t_{LONG BEACON PERIOD}. The beacons may have different amplitudes (I_{SHORT BEACON}, I_{LONG BEACON}) as show in FIG. 3A. The short beacon is followed by a long beacon 320 if a response is received to the short beacon. If load variation 330 is detected at the PTU after transmitting a short beacon, then the PTU transmits a long beacon and enters the Low Power State. The PTU also starts registration timer and transmits an advertisement as shown in FIG. 3A. If no response is received during the Low Power State, the PTU may return to the Power Save State. Conventional PTUs expend energy in both Power Save State and Low Power State.

FIG. 3B illustrates beacon signaling and Deep Sleep State according to one embodiment of the disclosure. Here, the PTU maintains an Idle Timer 340. During the Idle Timer, the PTU remains in Power Save State and transmits periodic short and long beacons similar to FIG. 3B. However, when the Idle Timer 340 expires, the PTU enters Deep Sleep State 350 where no energy is spent. During the Deep Sleep state 350, the PTU will not send any beacons which results in power conservation. In one embodiment, the PTU idle timer may be configured to expire after long beacon. Though not shown in FIG. 3B, the PTU may transition to Low Power State to initiate device registration through BLE communication if a PRU is discovered.

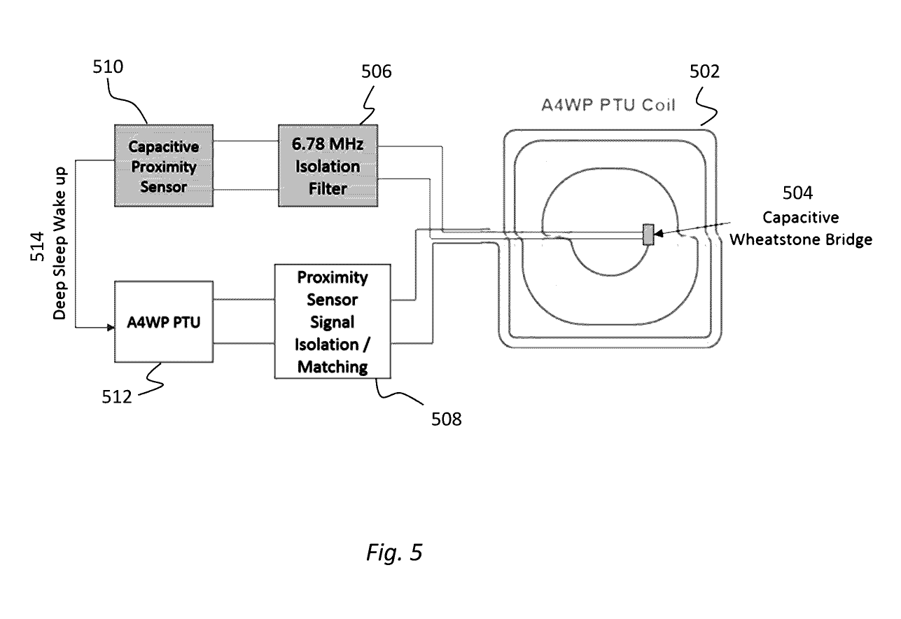

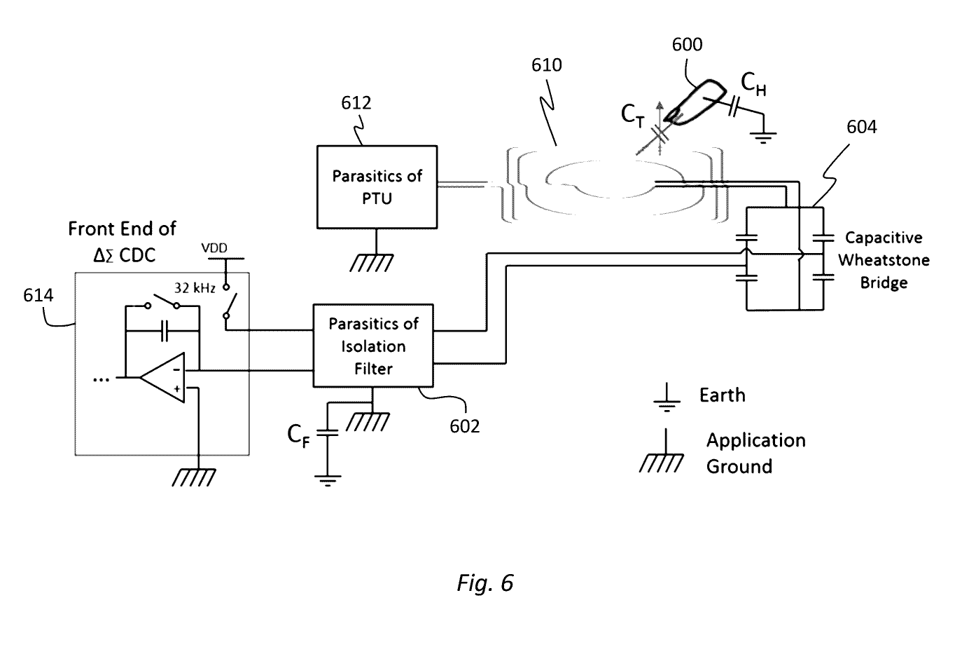

FIG. 4A shows a wake-up sequence according to the first exemplary embodiment of the disclosure. Specifically, FIG. 4A shows a beacon sequence coming out of the Deep Sleep state in reaction to false alarm 410 (i.e., no PRU present). Upon detecting event 450 (albeit false), the PTU may transition from PTU Deep Sleep state 420 to PTU Power Save state 430 and initialize beaconing. The PTU also starts PTU Idle Timer 440. If presence of a nearby object is not confirmed before Idle Timer 440 expires, the PTU may return to Deep Sleep State 420 to conserve power.

FIG. 4B shows transition to Low Power State to conserve power according to one embodiment of the disclosure. In one embodiment, the conventional A4WP polling scheme is modified to allow deep sleep wakeup to directly trigger long beacon 415. This may result in additional power saving gains as the long beacon starts the BLE advertisement 455 period. When a PRU is quickly detected in the active area of the PTU, the quick detection will shorten communication delay between devices which leads to faster transition to Low Power state 450. When the PTU enters Power Saving State 450, a long beacon is sent through the PTU coil. The PRU is then powered up by the long beacon and start sending advertisement through its BLE radio platform. Once PTU detects the PRU's BLE advertisement, it will progress to low power state and starts charging the PRU.

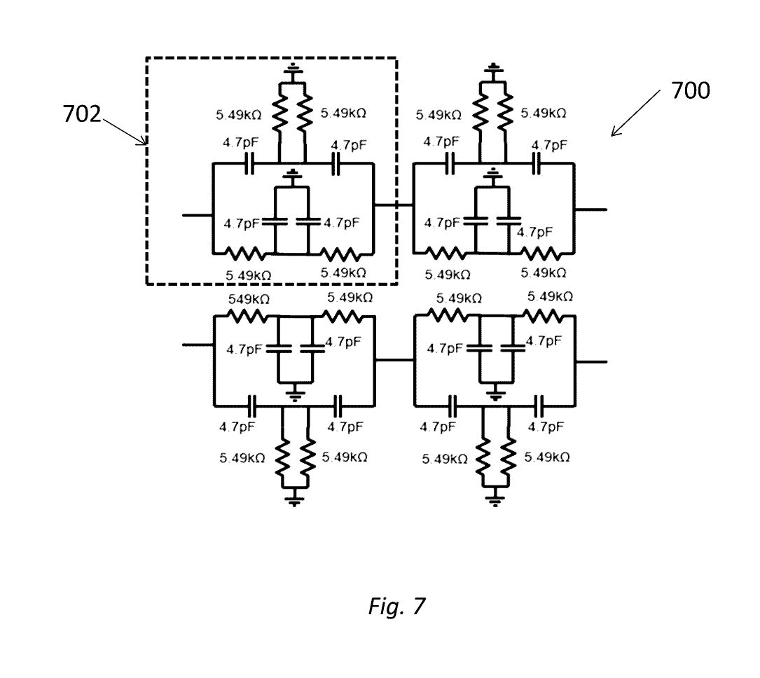

FIG. 5 shows an exemplary apparatus according to one embodiment of the disclosure where the PTU coil is shared by both wireless charging and proximity sensing simultaneously, without the need to switch back and forth. Specifically, FIG. 5 shows A4WP PTU Coil 502, Capacitive Bridge 504, Capacitive Proximity Sensor 510, Isolation Filter 506, Proximity Sensor Signal/Isolation Matching 508 and A4WP PTU 512. In FIG. 5, PTU coil 502 may be considered as two symmetrical halves. Capacitive Bridge 504 may be a Wheatstone Bridge. PTU Coil 205 may define two symmetrical haves with Capacitive Bridge 504. Capacitor Bridge 504 can isolate the sensor to define one half, and the PTU Coil which acts as a resonator may define the other half. Capacitor bridge 504 can isolate the two halves at the capacitive sensor operation frequency (10-100 kHz).

Filters 506 and 508 may act as isolation filters. Isolation Filter 506 is added at an interface between Coil 502 and Proximity Sensor 510. Isolation Filter 506 acts to filter out frequency of about 6.78 MHz to prevent the A4WP charging current from entering the proximity sensor circuitry (510). Isolation Filter 508 may be added between Coil 502 and PTU 512 to isolate the proximity sensing signal from A4WP PTU (512) circuitry. In one embodiment, the proximity sensor signal isolation circuit is part of the PTU matching circuit.

A4WP PTU 512 may comprise a conventional PTU back-end including circuitry to charge a PRU. When PTU 512 is in Deep Sleep state, Capacitive Proximity Sensor 510 continually sends proximity sensing signal through Capacitive Bridge 504 to Coil 502, where the coil 502 is used as proximity sensing electrode. If proximity sensor 510 senses event of user bringing PRU or other objects into proximity of the PTU coil, Capacitive Proximity Sensor 510 transmits one or more signals 514 to A4WP PTU 512 to awaken PTU 512 from deep sleep state. Once the PTU 512 is awake, it may enter Low Power State (e.g., State 450, FIG. 4B) and direct Coil 502 to engage in A4WP device/load detection by energizing Coil 502 to produce short or long beacons, at which point capacitive sensing stops. In some embodiments, the A4WP frequency (6.78 MHz) and capacitive sensor operation frequency are decades apart in frequency. This provides relatively relaxed constraints on the filters' Quality factor (Q) or frequency selectivity.

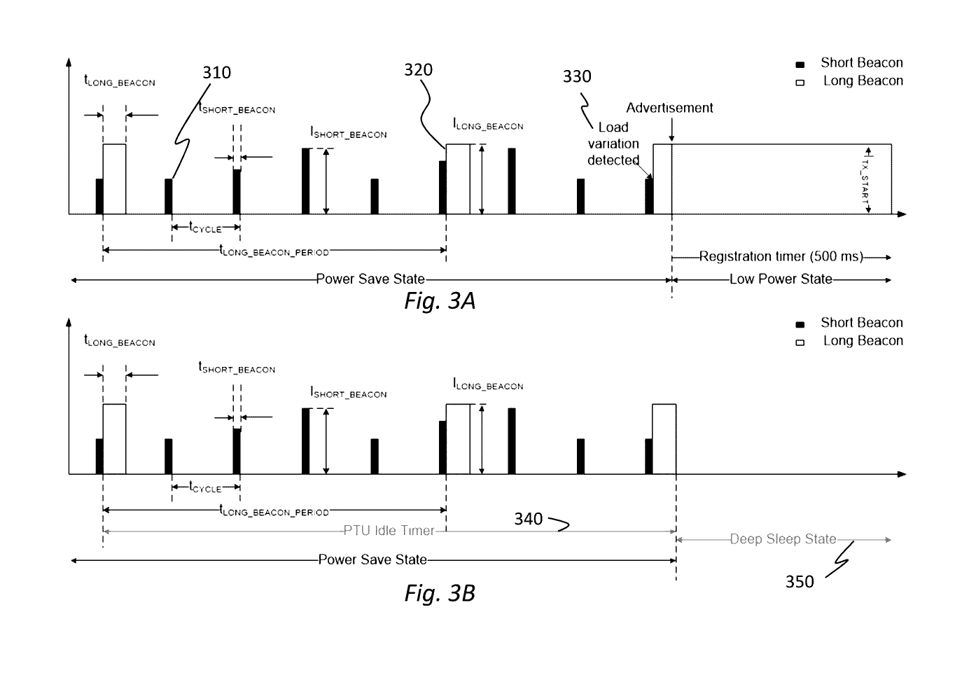

FIG. 6 illustrates another embodiment of the disclosure with an equivalent circuit for delta-sigma (ΔΣ) capacitive-to-digital-converter (DCD) sensor. In FIG. 6, capacitance which changes depending on the proximity of user 600 to coil 610 is shown as C_{T}. The human body has an effective capacitance to the earth, C_{H}, which is fed back to Bridge Circuit 604 through the effective capacitance of the circuit board to the earth, C_{F}, completing the loop. The human body in FIG. 6 is connected to a ground potential and is therefore detected by the capacitive sensor. One or more Isolation Filters 602 is added between the front-end of the Capacitive Proximity Sensor 604 and coil 602 to reject/filter wireless charging signal at 6.78 MHz. This ensures high accuracy of capacitance detection based on proximity sensing. Parasitic of PTU capacitance are removed by filter 612.

The circuit of FIG. 6 illustrates two novel circuits. First, the direct connection of an isolation filter 602 to the coil terminals with its hundreds of volts may result in a significant efficiency degradation and create a need for high power filter components. Wheatstone Capacitive Bridge circuit 604 may be used in place of the series capacitors. Capacitive Wheatstone Bridge circuit 604 reduces the amplitude visible to Isolation Filter 602 by allowing the common mode sensing of coil capacitance while rejecting effects of the coil current/voltage. Second, Isolation Filter 602 may further prevent the A4WP currents from impacting sensing. The isolation filters are inexpensive and have low capacitive loading.

Fig. 6 also shows a ΔΣ capacitance detection circuit which may be used for capacitance measurement/detection in some embodiments of the invention. The capacitor detection circuit uses the time it took to charge and discharge the capacitance under test in comparison with the time it took to charge and discharge a known reference capacitance to measure the capacitance value of the capacitor under test. With such device, the variation in capacitance introduced by user proximity Ct can be calculated, and when exceeding a certain threshold, a proximity event can be triggered.

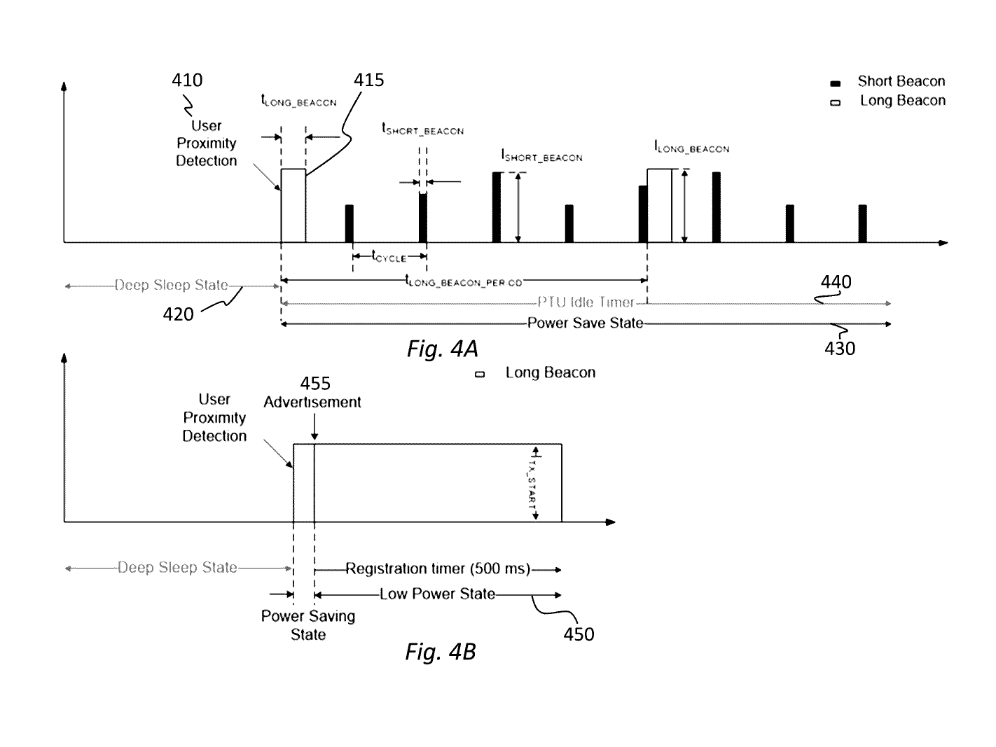

FIG. 7 shows an exemplary embodiment having an isolation filter according to one aspect of the disclosure. The isolation filter, to further prevent the A4WP currents from impacting the sensing, may be inexpensive and have low capacitive loading. FIG. 7 shows a two-stage differential Twin-T notch filter 700. The filter may be single ended as shown, fully differential, resonant, or even another capacitive Wheatstone bridge. The Twin-T notch filter may be designed to reject 6.78 MHz from feeding into the capacitive sensor.

To choose the Twin-T notch filters, consideration should be given to the output voltage of a single Twin-T 702 is close to ground. The top and bottom T's appear as two voltage dividers with the same Thevenin equivalent output impedance (½R//½ωC). At the notch frequency (RC=1/ω) the voltages at the junction of the T's are 90° out phase due to the exchange of C's and R's in the two right branches. The same effect occurs in the left branches when contributing to the output voltage adding another 90° lag. Thus at the notch frequency the two voltage outputs cancel justifying the initial assumption that the output is close to ground.

In some embodiments simulations suggest the impact on power draw is<50 mW at peak PTU power, significantly lower than alternative simultaneous operation schemes.

The following non-exclusive examples further illustrate certain embodiments of the disclosure. Example 1 is directed to a wireless charging apparatus, comprising: a resonator; a proximity sensor to detect presence of an object proximal to the resonator; a Power Transmission Unit (PTU) to communicate with the resonator and with the proximity sensor, the PTU configured to engage the resonator to generate a magnetic field in response to detected presence of the object.

Example 2 is directed to the wireless charging apparatus of example 1, wherein the proximity sensor is integrated with the resonator.

Example 3 is directed to the wireless charging apparatus of any of the preceding examples, wherein the proximity sensor further comprises a Wheatstone capacitive bridge.

Example 4 is directed to the wireless charging apparatus of any of the preceding examples, further comprising one or more switches for coupling and decoupling the resonator to one of the proximity sensor or to the PTU.

Example 5 is directed to the wireless charging apparatus of any of the preceding examples, wherein the one or more switches sequentially connect the resonator to the proximity sensor or to the PTU.

Example 6 is directed to the wireless charging apparatus of any of the preceding examples, further comprising an isolation filter connecting the proximity sensor to the resonator coil.

Example 7 is directed to the wireless charging apparatus of any of the preceding examples, further comprising a proximity sensor signal isolation circuit.

Example 8 is directed to the wireless charging apparatus of any of the preceding examples, wherein the object defines one or more of a wireless device, a human body or any tangible medium that is connected to a ground potential.

Example 9 is directed to a method to operate a wireless charging unit, the method comprising: receiving a signal from a proximity sensor identifying presence of a proximal object; transitioning the Power Transmission Unit (PTU) from a Deep Sleep state to a Low Power state; confirming presence of the proximal object as a Power Receiving Unit (PRU); and if presence of the PRU is confirmed, transmitting a magnetic field configured to charge the PRU.

Example 10. The method of example 9, wherein the step of confirming presence of the proximal object further comprises transmitting a long beacon followed by one or more short beacons.

Example 11 is directed to the method of any of the preceding examples, wherein the step of confirming presence of the proximal object further comprises starting an Idle timer.

Example 12 is directed to the method of any of the preceding examples, further comprising returning to Deep Sleep state if presence of the PRU is not detected at expiration of the Idle timer.

Example 13 is directed to the method of any of the preceding examples, further comprising transitioning the PTU from the a Deep Sleep state to Power Saving State before transitioning into Low Power State.

Example 14 is directed to the method of any of the preceding examples, further comprising transmitting one and only one long beacon during the Power Saving state.

Example 15 is directed to a non-transitory machine-readable medium comprising instructions executable by a processor circuitry to perform steps to wirelessly charge an external device, the instructions cause the processor circuitry to drive operations comprising: receiving a signal from a proximity sensor identifying presence of a proximal object; transitioning the Power Transmission Unit (PTU) from a Deep Sleep state to a Low Power state; confirming presence of the proximal object as a Power Receiving Unit (PRU); and if presence of the proximal object is confirmed, transmitting a magnetic field configured to charge the PRU.

Example 16 is directed to the non-transitory machine-readable medium of any of the preceding examples, wherein the operations further comprise confirming presence of the proximal object further comprises transmitting a long beacon followed by one or more short beacons.

Example 17 is directed to the non-transitory machine-readable medium of any of the preceding examples, wherein confirming presence of the proximal object further comprises starting an Idle timer.

Example 18 is directed to the non-transitory machine-readable medium of any of the preceding examples, further comprising returning to Deep Sleep state if presence of the PRU is not detected at expiration of the Idle timer.

Example 19 is directed to the non-transitory machine-readable medium of any of the preceding examples, further comprising transitioning the PTU from the a Deep Sleep state to Power Saving State before transitioning into Low Power State.

Example 20 is directed to the non-transitory machine-readable medium of any of the preceding examples, further comprising transmitting one and only one long beacon during the Power Saving state.

Example 21 is directed to a wireless charging apparatus, comprising: a resonator; a controller in communication with the resonator, the controller configured to awaken a power transmitting unit (PTU) to a Low Power state from a Deep Sleep state in response to presence indication of a proximal object.

Example 22 is directed to the apparatus of example 21, further comprising a sensor to identify presence of a proximal device or object that is connected to a ground potential.

Example 23 is directed to the apparatus of any of the preceding examples, wherein the controller is further configured to transition the PTU from the a Deep Sleep state to Power Saving state before transitioning into Low Power State.

Example 24 is directed to the apparatus of any of the preceding examples, wherein the controller directs transmission of one and only one long beacon during the Power Saving state.

Example 25 is directed to the apparatus of any of the preceding examples, wherein the controller directs the resonator to transmit a signal having an amplitude I_{TX}_{_}_{START} during the Low Power state.

Example 26 is directed to a wireless charging apparatus to detect a proximal chargeable device, comprising: means for generating a magnetic field; means for detecting presence of an object proximal to the generating means; means for communicating with the generating means and with the detecting means, the communicating means configured to engage the generating means to generate the magnetic field in response to detected presence of the object.

Example 27 is directed to the wireless charging apparatus of any of the preceding examples, wherein the means for detecting presence of the object is integrated with the means for generating a magnetic field.

Example 28 is directed to the wireless charging apparatus of any of the preceding examples, wherein the means for detecting further comprises a Wheatstone capacitive bridge.

Example 29 is directed to the wireless charging apparatus of any of the preceding examples, further comprising one or more switching means for coupling and decoupling the resonator to one of the proximity sensor or to the PTU.

Example 30 is directed to the wireless charging apparatus of any of the preceding examples, wherein the one or more switching means sequentially connect the resonator to the proximity sensor or to the PTU.

Example 31 is directed to the wireless charging apparatus of any of the preceding examples, further comprising a filtering means connecting the proximity sensor to the resonator coil.

Example 32 is directed to the wireless charging apparatus of any of the preceding examples, further comprising means for isolating the detecting means.

Example 33 is directed to the wireless charging apparatus of any of the preceding examples, wherein the object defines one or more of a wireless device, a human body or any tangible medium that is connected to a ground potential.

While the principles of the disclosure have been illustrated in relation to the exemplary embodiments shown herein, the principles of the disclosure are not limited thereto and include any modification, variation or permutation thereof.

What is claimed is:

1. A wireless charging apparatus, comprising:
a resonator;
a proximity sensor to detect presence of an object proximal to the resonator;
a Power Transmission Unit (PTU) to communicate with the resonator and with the proximity sensor, the PTU configured to engage the resonator to generate a magnetic field in response to detected presence of the object.

2. The wireless charging apparatus of claim 1, wherein the proximity sensor is integrated with the resonator.

3. The wireless charging apparatus of claim 1, wherein the proximity sensor further comprises a Wheatstone capacitive bridge.

4. The wireless charging apparatus of claim 1, further comprising one or more switches for coupling and decoupling the resonator to one of the proximity sensor or to the PTU.

5. The wireless charging apparatus of claim 4, wherein the one or more switches sequentially connect the resonator to the proximity sensor or to the PTU.

6. The wireless charging apparatus of claim 1, further comprising an isolation filter connecting the proximity sensor to the resonator coil.

7. The wireless charging apparatus of claim 1, further comprising a proximity sensor signal isolation circuit.

8. The wireless charging apparatus of claim 1, wherein the object defines one or more of a wireless device, a human body or any tangible medium that is connected to a ground potential.

9. A method to operate a wireless charging unit, the method comprising:
receiving a signal from a proximity sensor identifying presence of a proximal object;
transitioning the Power Transmission Unit (PTU) from a Deep Sleep state to a Low Power state;
confirming presence of the proximal object as a Power Receiving Unit (PRU); and
if presence of the PRU is confirmed, transmitting a magnetic field configured to charge the PRU.

10. The method of claim 9, wherein the step of confirming presence of the proximal object further comprises transmitting a long beacon followed by one or more short beacons.

11. The method of claim 10, wherein the step of confirming presence of the proximal object further comprises starting an Idle timer.

12. The method of claim 10, further comprising returning to Deep Sleep state if presence of the PRU is not detected at expiration of the Idle timer.

13. The method of claim 10, further comprising transitioning the PTU from the a Deep Sleep state to Power Saving State before transitioning into Low Power State.

14. The method of claim 13, further comprising transmitting one and only one long beacon during the Power Saving state.

15. A non-transitory machine-readable medium comprising instructions executable by a processor circuitry to perform steps to wirelessly charge an external device, the instructions cause the processor circuitry to drive operations comprising:
receiving a signal from a proximity sensor identifying presence of a proximal object;
transitioning the Power Transmission Unit (PTU) from a Deep Sleep state to a Low Power state;
confirming presence of the proximal object as a Power Receiving Unit (PRU); and
if presence of the proximal object is confirmed, transmitting a magnetic field configured to charge the PRU.

16. The non-transitory machine-readable medium of claim 15, wherein the operations further comprise confirming presence of the proximal object further comprises transmitting a long beacon followed by one or more short beacons.

17. The non-transitory machine-readable medium of claim 16, wherein confirming presence of the proximal object further comprises starting an Idle timer.

18. The non-transitory machine-readable medium of claim 16, further comprising returning to Deep Sleep state if presence of the PRU is not detected at expiration of the Idle timer.

19. The non-transitory machine-readable medium of claim 16, further comprising transitioning the PTU from the a Deep Sleep state to Power Saving State before transitioning into Low Power State.

20. The non-transitory machine-readable medium of claim 19, further comprising transmitting one and only one long beacon during the Power Saving state.

21. A wireless charging apparatus, comprising:
a resonator;
a controller in communication with the resonator, the controller configured to awaken a power transmitting unit (PTU) to a Low Power state from a Deep Sleep state in response to presence indication of a proximal object.

22. The apparatus of claim 21, further comprising a sensor to identify presence of a proximal device or object that is connected to a ground potential.

23. The apparatus of claim 22, wherein the controller is further configured to transition the PTU from the a Deep Sleep state to Power Saving state before transitioning into Low Power State.

24. The apparatus of claim 23, wherein the controller directs transmission of one and only one long beacon during the Power Saving state.

25. The apparatus of claim 21, wherein the controller directs the resonator to transmit a signal having an amplitude I_{TX}_{_}_{START} during the Low Power state.
